(19) United States
(12) Patent Application Publication
(10) Pub. No.: US 2025/0259046 A1
(43) Pub. Date: Aug. 14, 2025

(54) SYSTEMS AND METHODS FOR INTEGRATION OF NETWORK BASED SERVICES, INCLUDING NETWORK BASED SECURITY SERVICES, INTO DESKTOP ENVIRONMENTS

(71) Applicant: Open Text Holdings, Inc., Menlo Park, CA (US)

(72) Inventors: Sindhu Rajatadri Divakara, Bengaluru (IN); . Sangamesh, Bengaluru (IN); Sarthak Sachdeva, Bengaluru (IN); Marthala Srinivasareddy, Bengaluru (IN)

(21) Appl. No.: 18/438,804

(22) Filed: Feb. 12, 2024

(51) Int. Cl. H04L 67/025; G06F 16/955; H04L 9/40

(52) U.S. Cl. CPC G06N 3/0475

(57) ABSTRACT

Embodiments of systems and methods for integration of services into the provisioning of functionality for desktop applications on desktop computing devices using an embedded web browser at the desktop computing device adapted to access web pages incorporating libraries adapted for use with such services are disclosed.

### TECHNICAL FIELD

This disclosure relates generally to integration of network based service providers into certain computing environments, including the integration of network based computer security providers into those computing environments. More particularly, this disclosure relates to embodiments of systems and methods for the use of secure authentication mechanisms in distributed computing environments. Even more specifically, this disclosure relates to embodiments of systems and methods for the integration of secure authentication mechanisms adapted for network based applications into desktop computing environments.

### BACKGROUND

Ever since the advent of computer networks (including the Internet), distributed computing environments have been steadily growing more complicated, encompassing an ever-expanding amount of increasingly complex functionality. Thus, there is often times a need to incorporate or utilize functionality available at one location (e.g., physical or virtual location, machine, or process) into functionality implemented at another location. In fact, various architectures and standards have been developed to do just that. For example, web services (or just “services”) have been developed to support interoperation and interactions of machines or processes over computing networks.

A web service fulfills a specific task or a set of tasks that can be requested (e.g., from another location) using a defined interface for that web service. The result can then be returned to the requestor. To facilitate the use of these services, certain providers of these services have even created Software Development Kits (SDK) to assist providers of computing functionality in incorporating these services into their functionality. Accordingly, providers of computing functionality (e.g., applications) may utilize such distributed computing services (whether provided by the same provider or a third-party provider) in the provisioning of their functionality.

Computer security represents a microcosm of this situation. To illustrate in more detail, providers of computing functionality may frequently utilize a secure authentication service to detect suspicious activity, such as the presence of bots, unauthorized access attempts, or misuse of accounts. Requests for authentication or the like may be sent to such a secure authentication service and responses with validity data (e.g., a risk score, binary approval, or other validity data) regarding those users may be returned from that secure authentication service. This validity data may empower decision-making by providers of computer functionality regarding, for example, allowing or blocking devices, IP addresses, or users.

The mechanisms by which these types of services (security or otherwise) may be accessed or otherwise utilized may, however, be confined to certain computing environments. As but one example, certain of these services may only be accessible through a mobile application executing on a mobile device or a browser based application.

What is desired, therefore, are systems and methods that allow the use of these services in a wide variety of computing environments. In particular, it may be desirable to allow such services to be utilized in a desktop computing environment.

### SUMMARY

As previously discussed, providers of computing functionality (e.g., applications) may utilize distributed computing services (whether provided by the same provider or a third-party provider) in the provisioning of their functionality. The mechanisms by which services may be integrated with the provisioning applications may be heavily dependent on the libraries provided for use with those servers (e.g., the client side or server side libraries, as discussed). Many times, however, the use of such libraries is constrained by the computing environment in which applications operate. Specifically, certain of these libraries may only be utilized with applications adapted for use on mobile devices in mobile computing environments or browser based applications adapted for use on browsers in a browser based computing environment.

Thus, the user of certain services may be unavailable in certain computing environments, even where providers of computing applications may desire to integrate or use the functionality of such services. Namely, many providers of computing functionality may also offer desktop applications. Providers of these desktop applications may still desire to utilize functionality of service providers in providing these desktop applications. What is desired then, is the ability to allow the functionality of such services to be utilized in a desktop computing environment.

To address those desires, among other ends, embodiments as disclosed may provide a mechanism for the integration of such services into a desktop computing environment. Specifically, according to one embodiment, a desktop application may include or invoke a service access module that may be executed when the user accesses a (e.g., user) interface of the desktop application (or takes a certain action with respect to that interface). The service access module may invoke or otherwise create a web browser. The web browser may thus be embedded into the service access module. This service access web page may incorporate a client side library associated with a service provider.

As the service access web page includes the client side library for the service provider it may call the client side library to obtain client side service data. This client side service data can be obtained by the service access module and included in a request such that the client side data can be used when utilizing the service provided by the service provider. In this way, the functionality of the service provider can be accessed in association with a desktop application using the libraries provided by the service provider despite that such libraries may only be suitable for use in a mobile application or browser based computing environment.

For example, in one embodiment incorporating the use of services into desktop applications may include determining an access to an interface of a desktop application executing on a computing device and executing a service access module. The service access module can be adapted to invoke a web browser in the service access module, where the web browser is configured to access a Uniform Resource Locator (URL) for a service access web page associated with a first service and including a library associated with the first service.

The service access module can receive the service access web page including the library (e.g., at the web browser). Utilizing the service access web page, the library associated with the first service can be called to generate client side service data associated with the first service at the computing device. A first request including the client side service data can be sent from the service access module at the computing device to an intermediary server, wherein the first request is for a second service provided by the intermediary server.

The first request causes a second request to be sent from the intermediary server to a service provider of the first service, the second request including the client side service access data. A first response to the second request is received from the service provider at the intermediary server, wherein the first response includes service data determined by the service provider.

A second response to the first request is determined at the intermediary server based on the service data from the first response and the second response is returned to the service access module at the computing device. Using this second response, the service access module can update the (e.g., interface of) desktop application based on the second response.

In some embodiments, the web browser can be executing in a process space of the service access module and adapted to only access the configured URL.

In one embodiment, the interface is a login interface of the desktop application. In certain embodiments, the service access data generated by the library is a request token associated with the computing device and the service data includes a risk access score associated with the request token.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIGS. 1A and 1B are diagrammatic representations of architectures for the integration of services into distributed computing environments.

FIGS. 2A and 2B are diagrammatic representations of embodiments of architectures for the integration of services into desktop computing environments.

FIGS. 3A and 3B (collectively FIG. 3) is a diagrammatic representation of one embodiment of an architecture and method for incorporating a security service into a login flow for a desktop application in a desktop computing environment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions or rearrangements within the spirit or scope of the underlying inventive concept will become apparent to those skilled in the art from this disclosure.

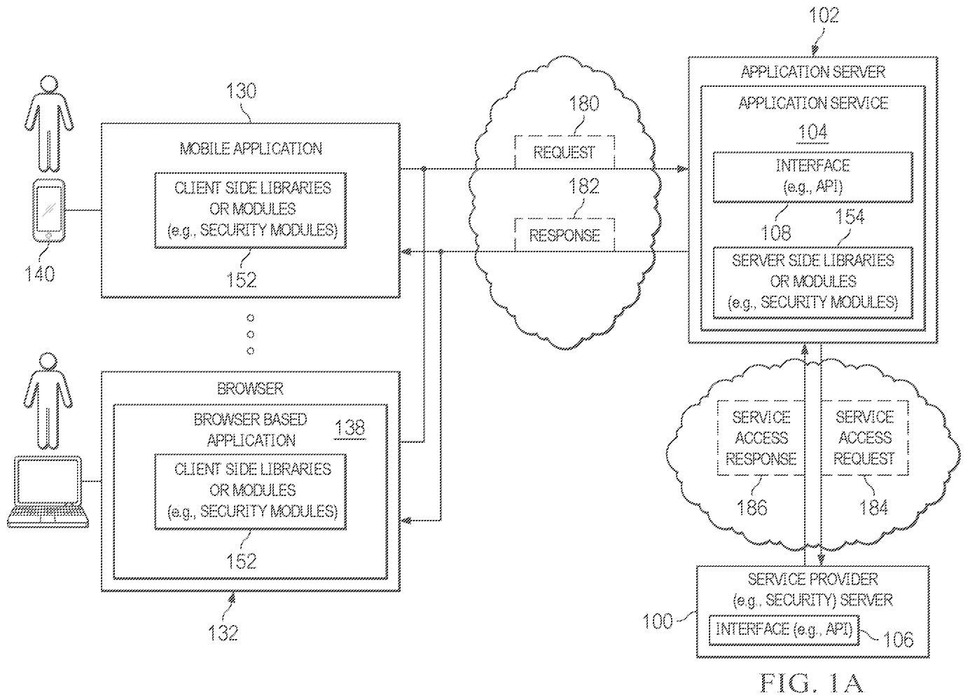

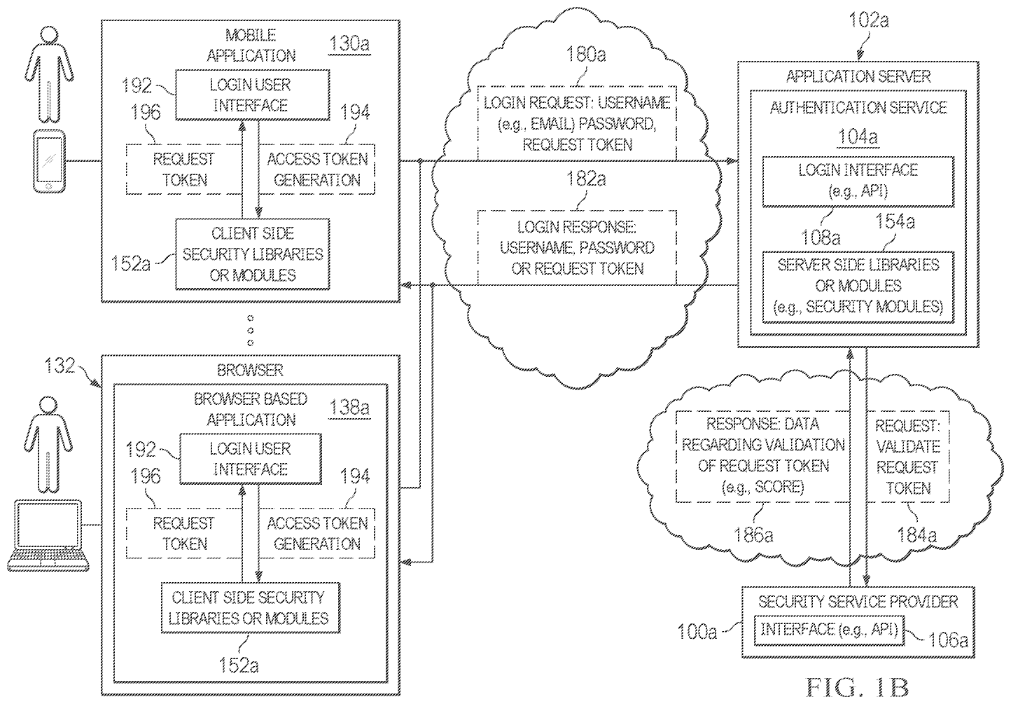

Before delving into embodiments in more detail some additional context may be helpful. Referring first to FIGS. 1A and 1B, architectures for the integration of services into distributed computing environments are depicted. Specifically, FIG. 1A depicts a general architecture for the integration of a service into a distributed computing environment while FIG. 1B depicts more specific example of an architecture where a security service is incorporated into a login flow (or other type of user verification or validation) for an application in a distributed computing environment.

Looking initially at FIG. 1A, then, a provider of a computer functionality may provide a computing application for use at a user's computing device. Such applications may include a mobile application (or “app”) 130 that may execute on mobile device 140 such as a smartphone, tablet, or other type of mobile computing device. For example, mobile application 130 may be an application adapted for execution in an Android® or iOS® environment. Thus, a user may start, and interact with, the mobile application 130 to access desired functionality offered by the mobile application 130.

Similarly, an application to access computing functionality may also include a browser based application 138 that comprises one or more web pages including underlying code, that is typically written in a combination of markup language such as extensible Markup Language (XML), hypertext markup language (HTML), cascading style sheets (CSS), or JavaScript (although other types and combinations of markup, programming languages combinations are possible as well and are fully contemplated herein). Thus, this browser based application 138 may be executed (e.g., interpreted) by browser 132 executing on user's computing device (e.g., any type of computing device that is capable of executing browser 132) and the user can thus access the desired functionality offered by browser based application 138 through browser 132.

In modern distributed computing systems, distributed computing applications (e. g., mobile application 130 and browser based application 138) may utilize a client server or similar type of architecture whereby the functionality of the application is provided, at least in part, using application server 102. Thus, mobile application 130 or browser based application 138 may send requests (e.g., HTML requests, web services requests, etc.) to application server 102 and application server 102 may return an appropriate response that may include, for example, content (e.g., web pages), instructions, or other data for providing the desired functionality through mobile application 130 or browser based application 138.

Mobile application 130, browser based application 138 and application server 102 (or the data it provides) may, for example, utilize representational state transfer (REST) interfaces. REST is an architectural style that abstracts architectural elements within a distributed computing system. REST is a commonly used web application program interface (API) design model. In the REST model, the (e.g., client) application (mobile application 130 or browser based application 138) is presented utilizing a network of (e.g., web) pages, and the user interacts with the application by selecting links (state transitions), resulting in the next page (representing the next state of the application) being requested from (a service of) application server 102 (e.g., by mobile application 130 or through browser 132 by browser based application). In response the next page (or other content) can be sent from the (service on) application server 102, and rendered by the application (e.g., mobile application 130 or browser based application 138) for the user.

For a variety of reasons, providers of mobile application 130 or browser based application 138 may desire to utilize functionality offered by a service provider 100 in the provisioning of the computing functionality offered by mobile application 130 or browser based application 138. Such a service provider 100 may, for example, be affiliated or implemented by operators of application server 102 or by a third party. Service provider 100 may implement a specific task or a set of tasks that can be requested (e.g., from another location) using a defined interface (e.g., API) 106 for that service. The result can then be returned to the requestor. While a wide variety of tasks may be implemented using a service provider 100, some commonly implemented services pertain to security in a networked computing environment.

Accordingly, functionality of service provider 100 may be utilized by providers of computing functionality (e.g., provider of mobile application 130, browser based application 138 and application server 102) to provide such computing functionality. To illustrate in more detail, in certain cases service provider 100 may provide a SDK or other type of libraries of modules to facilitate use of their service (e.g., the incorporation of the functionality of their offered service into the computing environment of mobile application 130 or browser based application 138). The libraries or modules (collectively referred to as a library without loss of generality) can, for example, include a client side library 152 and a server side library 154.

Providers of mobile application 130 and browser based application 138 can thus incorporate client side library 152 into mobile application and browser based application 138. Mobile application 130 and browser based application 138 may thus be adapted to call such client side libraries 152 and cause the generation of a request 180 to an interface at application server 102. This request 180 may be a request for functionality associated with a service provided by service provider 100 or may be a request for another type of functionality that is provided by application server 102 that may utilize or otherwise involve service provider 100.

For example, mobile application 130 or browser based application 138 may call client side library 152 to obtain client side service data to include in request 180, and generate request 180 based on such client side service data. This request 180 may be directed to an interface 108 associated with application service 104 provided on application server 102. Thus, mobile application 130 and browser based application 138 may be unaware that the request involves service provider 100 (e.g., may not send a request directly to service provider 100).

Application service 104 may incorporate (or otherwise utilize) server side library 154 provided by service provider 100. Thus, when the request 180 from the application 130, 138 is received at the application service 104 through interface 108, application service 104 may utilize this server side library 154 to generate a service access request 184 to interface 106 for the service provided by service provider 100. This service access request 184 may include client side service data included in request 180 sent from mobile application 130 or browser based application 138, or data generated by application service 104 or server side library 154 based on such client side service data.

Service provider 100 can then perform the service (e.g., task) requested by service access request 184 and return service access response 186 to application service 104 on application server 102. This service access response 186 may include service data determined by service provider 100 based on the service access request 184 (e.g., and the included client side service data or data generated at application service 104 included in the service access request 184).

Application service 104 can use the service data included in service access response 186 to formulate response 182 to request 180 from mobile application or browser based application 138 (e.g., in performing any service or task requested by request 180) and send this response 182 back to mobile application 130 or browser based application 138 which will act according to such a response 182. In this manner, the functionality offered by service provider 100 may be utilized in (integrated with) the provisioning of the computing functionality offered by mobile application 130 or browser based application 138 (e.g., by utilizing functionality offered by service provider 100 in performing tasks by application service 104 at application server 102).

It may now be helpful to look at the incorporation of a particular type of service into a specific aspect of the functionality of a mobile application or browser based application. Turning then to FIG. 1B, a distributed computing environment where a security service is incorporated into a login flow for an application is depicted. Here, service provider 100a may be a security service that provides security data on devices or users in a network such as a cybersecurity, threat, or device intelligence platform. This security data may include, for example, risk scores, risk signals, definitive determinations on whether to allow (or deny) access, device fingerprinting, lists, policies, or other types of data. Examples of such security services or platforms include, for example Castle, or BrightCloud® by OpenText®. Client side security library 152a and server side library 154a may thus allow the functionality of security service provider 100a to be integrated with the provisioning of functionality of mobile application 130a and browser based application 138a.

Accordingly, security service provider 100a may be utilized in authentication (e.g., validation or verification) of a user during a login process for mobile application 130a or browser based application 138a (collectively application 130a, 138a).

Thus, a user may start, and interact with, application 130a, 138a to access desired functionality offered by the application 130a, 138a. As an initial interaction application 130a, 138a may present a login user interface 192 where the user may enter user credentials (e.g., a username such as an email and a corresponding password).

When a user provides such credentials through this login interface 192 (e.g., an enters “return” or clicks a “login” button), login interface 192 (e.g., code of the page comprising the login interface 192) may be adapted to access token 194 (e.g., call or send a request to) client side libraries 152a for the generation of a token (e.g., referred to as “request token” by certain security service providers 100a and referred to herein as a request token in places without loss of generality). This token may include, or be determined based on, device or user information, or other types of identifying information. Client side security library 152a (e.g., the called function of the library 152a) may then generate such a request token 196 and return the request token to the login user interface 192.

Login interface 192 can then generate login request 180a to login interface 108a of an authentication service 104a at application server 102a. This request 180a may be an HTTP POST and include, for example, the user credentials (e.g., username and password provided by the user) and the request token generated by the client side security library 152a.

Authentication service 104a may incorporate or otherwise utilize) server side library 154a provided by security service provider 100a. Thus, when the login request 180a from application 130a, 138a is received at the authentication service 104a through interface 108a, authentication service 104a may utilize this server side library 154a to generate a request for validation 184a to interface 106a of security service provider 100a, where that request for validation 184a includes the request token (e.g., as generated by client side library 152a).

Security service provider 100a can then perform the validation requested by the validation request 184a and return validation response 186a to authentication service 104a on application server 102a. This validation response 186a may include validity data determined by security service provider 100a based on the validation request 184a (e.g., based on the request token generated by client side library 152a) such as risk score, binary approval, or other validity data.

Authentication service 104a can use validity data included in validation response 186a to formulate response 182a to login request 180a from application 130a, 138a. In particular, authentication service 104a may determine whether to authenticate the user based on the validity data (e.g., and the submitted username and password, etc.). The authentication service 104a can then send response 182a back to login interface 192 of application 130a, 138a, where that response may include authentication data associated with the login request 180a, including for example an approval or denial of the authentication of the user.

Login interface 192 can then use the authentication data included in the login response 182a to either allow the user access to (e.g., functionality of) application 130, 138 or deny the user access (e.g., present an error message). In this manner, the security functionality offered by security service provider 100a may be utilized to increase security in the application 130, 138.

As may be realized, then, the mechanisms by which services may be integrated with the provisioning applications are heavily dependent on the libraries provided for use with those servers (e.g., the client side or server side libraries, as discussed). Many times, however, the use of such libraries are constrained by the computing environment in which applications operate. Specifically, certain of these libraries may only be utilized with applications adapted for use on mobile devices in mobile computing environments or browser based applications adapted for use on browsers in a browser based computing environment. That this situation exists may be for a variety of reasons, including the more generic or standard nature of the implementation or design of such applications, the relative assurance of particular types of network connectivity in such environments, the lack of desire by providers of such service to port their libraries to a large number of platforms, or for other reasons.

Thus, the user of certain services may be unavailable in certain computing environments, even where providers of computing applications may desire to integrate or use the functionality of such services.

Namely, many providers of computing functionality may also offer desktop applications. Desktop applications are software programs run locally (e.g., natively) on (e.g., the operating systems of) computer devices. Such desktop applications are usually not accessible through a browser and require deployment on the computing device. These desktop applications may, however, still access or utilize functionality provided over a network, including acting as a client in a client server environment access services provided by an (e.g., application) server. Although service providers may not provide simple mechanisms (e.g., libraries) for integrating functionality they provide into desktop applications, providers of these desktop applications may still desire to utilize such functionality in providing these desktop applications. What is desired then, is the ability to allow the functionality of such services to be utilized in a desktop computing environment.

To address those desires, among other ends, embodiments as disclosed may provide a mechanism for the integration of such services into a desktop computing environment. Specifically, according to one embodiment, a desktop application may include or invoke a service access module that may be executed when the user accesses a (e.g., user) interface of the desktop application (or takes a certain action with respect to that interface). Such an interface may, for example, be an extensible Application Markup Language (XAML) based interface. The service access module may invoke or otherwise create a web browser. The web browser may thus be embedded into the service access module. The service access module (e.g., including the web browser) can thus be executing in the process space of the desktop application or the particular interface of the desktop application.

The creation of the browser may include, for example, creating a WebView Controller (e.g., an instance of a WebViewController class such as that offered in certain programming or scripting languages or packages) or the like. The created web browser may be hidden from a user and adapted to access a particular Uniform Resource Locator (URL) associated with a service access web page. This service access web page may incorporate a client side library associated with a service provider. Such a service access web page may be, for example, an Angular web page or a web page implemented in another web application framework. Moreover, to increase security, the web browser (or WebView Controller) may be limited to accessing only the configured URL for the service access web page. Limiting the web browser in this manner may be accomplished in one embodiment, by creating the browser (e.g., the WebView Controller) using a delegate method in the service access module.

As the service access web page includes the client side library for the service provider, it may call the client side library to obtain client side service data. This client side service data can be obtained by the service access module and included in a request such that the client side data can be used when utilizing the service provided by the service provider. In this way, the functionality of the service provider can be accessed in association with a desktop application using the libraries provided by the service provider despite that such libraries may only be suitable for use in a mobile application or browser based computing environment.

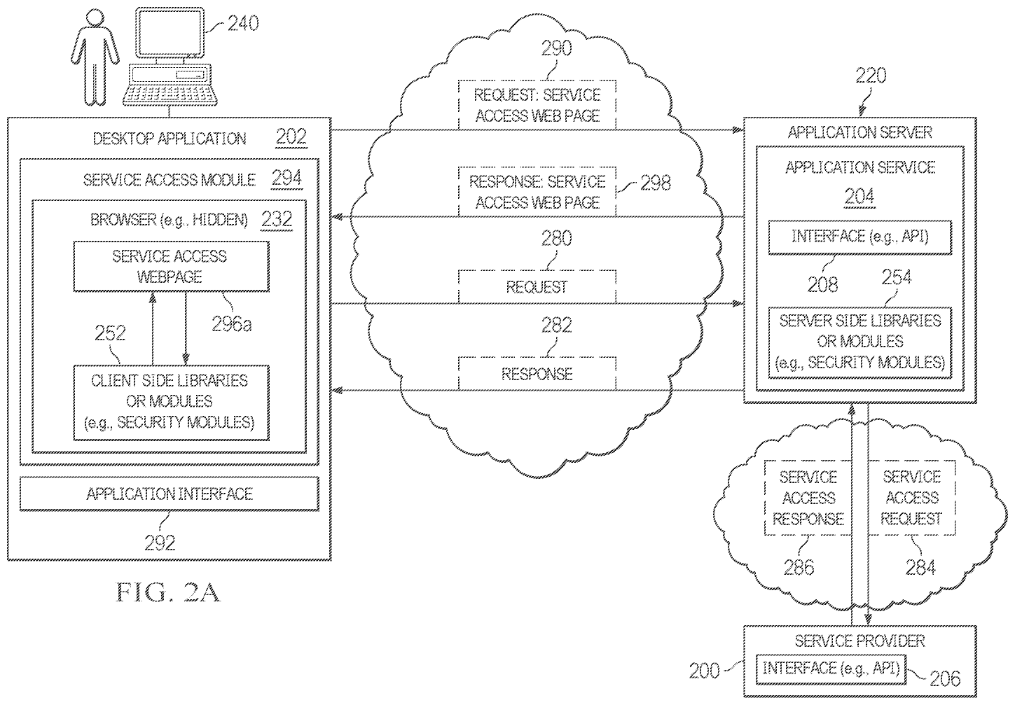

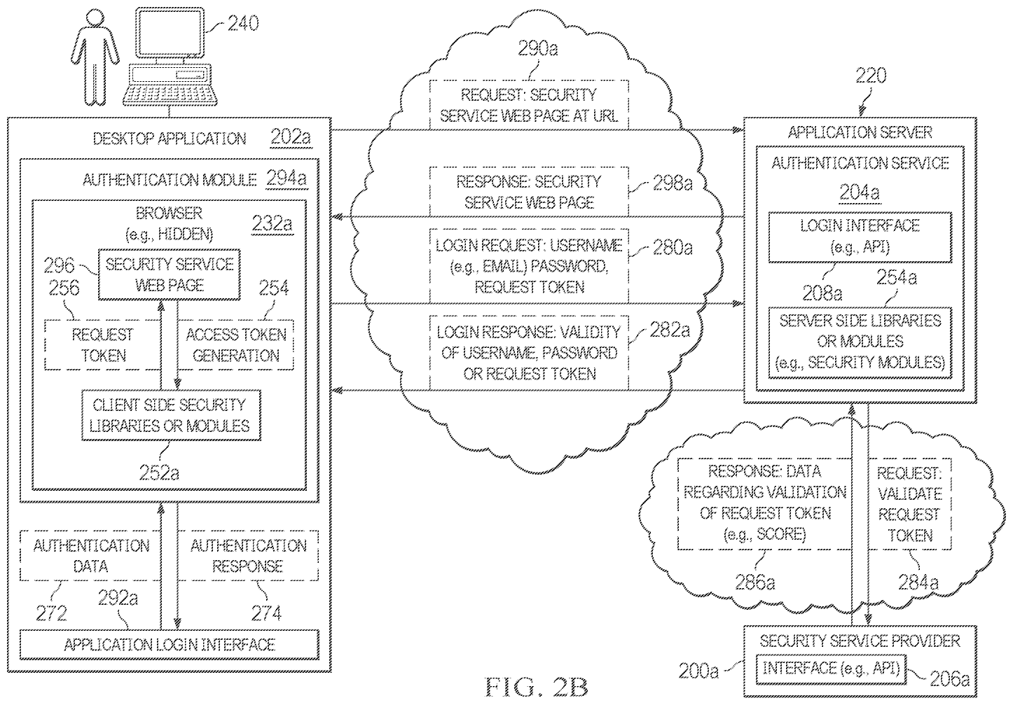

Now moving to FIGS. 2A and 2B, embodiments of architectures for the integration of services into desktop computing environments are depicted. Specifically, FIG. 2A depicts an embodiment of a general architecture for the integration of a service into a desktop computing environment, while FIG. 2B depicts a specific embodiment of an architecture where a security service is incorporated into a login flow (or other type of user verification or validation) for a desktop application in a desktop computing environment.

With respect to FIG. 2A, then, a provider of a computer functionality may provide a computing application for use at a user's computing device. Such applications may include a desktop application 202 that may execute on a computing device 240 such as a personal computer, laptop, mobile computing device (e.g., smartphone), tablet, or other type of computing device. For example, desktop application 202 may be an application adapted for native execution on an operating system of the computing device 240 (e.g., that may have compiled or translatable instructions that may be executed or translated locally on the computing device utilizing the operating systems of the computing device). Thus, a user may start, and interact with, the desktop application 202 to access desired functionality offered by the desktop application 202.

Desktop application 202 may include a (e.g., user) interface 292 such as an XAML based interface. When the user accesses interface 292 of the desktop application 202 (or takes a certain (inter) action with respect to that interface: 292), the interface 292 (or desktop application) may invoke or otherwise execute service access module 294 that is included in the application interface 292 or desktop application 202. The service access module 294 may, in turn, invoke or otherwise create web browser 232. The web browser 232 may thus be embedded in service access module 294. The service access module 294 (e.g., including the web browser 232) can thus be executing in the process space of desktop application 202 or the particular interface 292 of the desktop application 202.

The created web browser 232 may thus be hidden from a user and be adapted to access a particular URL associated with a service access web page 296. The creation of browser 232 may include, for example, creating a WebView Controller (e.g., an instance of a WebViewController class such as that offered in certain programming or scripting languages or packages) or the like.

To increase security, the web browser 232 (or WebView Controller) may be limited to accessing only the configured URL for the service access web page 296. Limiting the web browser 232 in this manner may be accomplished in one embodiment, by creating the browser 232 (e.g., through the WebView Controller) using a delegate method in the service access module, or monitoring or confining the URLs accessed by browser 232 to only the configured URL.

Accordingly, web browser 232 may issue a service access web page request 290 to the URL (e.g., an HTTP GET for the URL). A (e.g., web) server corresponding to this URL may be provided, for example, by application server 220 such that the service access web page 296 may be returned in a service access web page response 298 to this service access web page request.

This service access web page 296 may incorporate client side library 252 associated with service provider 200. Such a service access web page 296 may be, for example, an Angular web page or a web page implemented in another web application framework. As the service access web page 296 includes the client side library 252 for service provider 200, the service access web page 296 (or service access module 294) may call the client side library 252 to obtain client side service data. Such a call may, for example, be performed by a delegate method of service access module 294 or service access web page 296. This client side service data can be obtained (e.g., through web page 296 or browser 232) by the service access module 294, and a request 280 generated that includes this obtained client side service data. This request 280 may be generated by service access module 294 using, for example, a delegate method or the like. This request 280 may be, for example, for a service (e.g., functionality) associated with application interface 292.

Request 280 may be directed to an interface 208 associated with application service 204 provided on application server 220 (or another type of intermediary server as will be understood). For example, this application service 204 may be adapted to perform a requested service (e.g., functionality) associated with application interface 292. Application service 204 may incorporate (or otherwise utilize) server side library 254 provided by service provider 200. Thus, when the request 280 from the service access module 294 is received at the application service 204 through interface 208, application service 204 may utilize this server side library 254 to generate a service access request 284 to interface 206 of a service provided by service provider 200. This service access request 284 may include client side service data included in request 280 sent from service access module 294, or data generated by application service 204 or server side library 254 based on such client side service data.

Service provider 200 can then perform the service (e.g., task) requested by service access request 284 and return service access response 286 to application service 204 on application server 220 This service access response 286 may include service data determined by service provider 200 based on the service access request 284 (e.g., and the included client side service data generated by service access module 294 or data generated at application service 204 that is included in the service access request 284).

Application service 204 can use the service data included in service access response 286 to formulate response 282 to request 280 from service access module 294 and send this response 282 back to service access module 294 which will act according to (the data in) such a response 282. Such action may include updating desktop application 202 (e.g., updating interface 292 or presenting another interface 292 of desktop application 202). Additionally, service access module 294 may cleanup or terminate, including termination and cleanup of browser 232. In this manner, the functionality offered by service provider 200 may be utilized in (integrated with) the provisioning of the computing functionality offered by a desktop application using libraries provided by that service provider 200, even when such libraries are not adapted to be utilized in a desktop computing environment.

Embodiments may thus be utilized to integrate a wide variety of services into desktop environments. FIG. 2B depicts a specific embodiment of an architecture where a security service is incorporated into a login flow (or other type of user verification or validation) for a desktop application in a desktop computing environment. Here, service provider 200a may be a security service that provides security data on devices or users in a network such as a cybersecurity, threat, or device intelligence platform. This security data may include, for example, risk scores, risk signals, definitive determinations on whether to allow (or deny) access, device fingerprinting, lists, policies, or other types of data. Examples of such security services or platforms include, for example Castle, or BrightCloud® by OpenText®. Embodiments may thus allow client side security library 252a and server side security library 254a to be utilized to provide the functionality of security service provider 200a in association with the provisioning of functionality of desktop application 202a.

Accordingly, security service provider 200a may be utilized in authentication (e.g., validation or verification) of a user during a login process for desktop application 202a. Thus, a user may start, and interact with, desktop application 202a to access desired functionality offered by the desktop application 202a. As an initial interaction desktop application 202a may present a login user interface 292a where the user may enter user credentials (e.g., a username such as an email and a corresponding password).

When a user provides such credentials through this login interface 292a (e.g., an enters “return” or clicks a “login” button), login interface 292 (e.g., code of the page comprising the login interface 292) may be adapted to invoke or otherwise execute authentication module 294a and pass the authentication module 294a authentication data 272 (e. g., the user credentials entered by the user). The authentication module 294a may, in turn, invoke or otherwise create web browser 232a. The web browser 232a may thus be embedded in authentication module 294a. The authentication module 294a (e.g., including the web browser 232) can thus be executing in the process space of desktop application 202a or the particular login interface 292a of the desktop application 202a.

The creation of browser 232 may include, for example, creating a WebView Controller (e.g., an instance of a WebViewController class such as that offered in certain programming or scripting languages or packages) or the like. The created web browser 232a may be hidden from a user and be adapted to access a particular URL associated with security service web page 296a.

Accordingly, web browser 232a may issue a security service web page request 290a to the URL (e.g., an HTTP GET for the URL). A (e.g., web) server corresponding to this URL may be provided, for example, by application server 220a such that the security service web page 296a may be returned to the browser 232 in a security service web page response 298a to the security service web page request 290a.

The returned security service web page 296a may incorporate client side library 252a associated with security service provider 200a. As the security service web page 296a includes the client side library 252a for security service provider 200a, the security service web page 296 may access 244 (e.g., call or send a request to) client side libraries 252a for the generation of a request token. Client side security library 252a (e.g., the called function of the library 252a) may then generate such a request token and return 256 the request token to the security service web page 296.

This request token can be obtained (e.g., through web page 296a or browser 232a) by the authentication module 294a, and authentication module 294a may generate login request 280a to login interface 208a of an authentication service 204a at application server 208a. This request 280a may be an HTTP POST and include, for example, the user credentials (e.g., username and password provided by the user) and the request token generated by the client side security library 252a.

Authentication service 204a may incorporate (or otherwise utilize) server side library 254a provided by security service provider 200a. Thus, when the login request 280a from authentication module 294a is received at the authentication service 204a through interface 208a, authentication service 204a may utilize this server side library 254a to generate a request for validation 284a to interface 206a of security service provider 200a, where that request for validation 284a includes the request token (e.g., as generated by client side library 252a).

Security service provider 200a can then perform the validation requested by the validation request 284a and return validation response 286a to authentication service 104a on application server 202a. This validation response 286a may include validity data determined by security service provider 200a based on the validation request 284a (e.g., based on the request token generated by client side library 252a) such as risk score, binary approval, or other validity data.

Authentication service 204a can use validity data included in validation response 286a to formulate response 282a to login request 280a from authentication module 294a. In particular, authentication service 204a may determine whether to authenticate the user based on the validity data returned from security service provider 200a (e.g., and the submitted username and password, etc.). The authentication service 204a can then send response 282a back to authentication module 294a, where that response may include authentication data responsive to the login request 280a, including for example an indication of the validity of the request token, username or password or an approval or denial of the authentication of the user.

Authentication module 294a can then use the authentication data included in the login response 282a to make a determination to either allow the user access to (e.g., functionality of) desktop application 202a or deny the user access to desktop application 202a. Based on this determination the authentication module 294a may provide an authentication response 274. This authentication response 274 may cause the login interface 292a to present an error message in cases where a determination to deny a user access have been made, or to update the desktop application interface or present another interface of desktop application when a decision is made to allow the user access to the functionality of desktop application. Additionally, authentication module 294a may cleanup or terminate, including termination and cleanup of browser 232a.

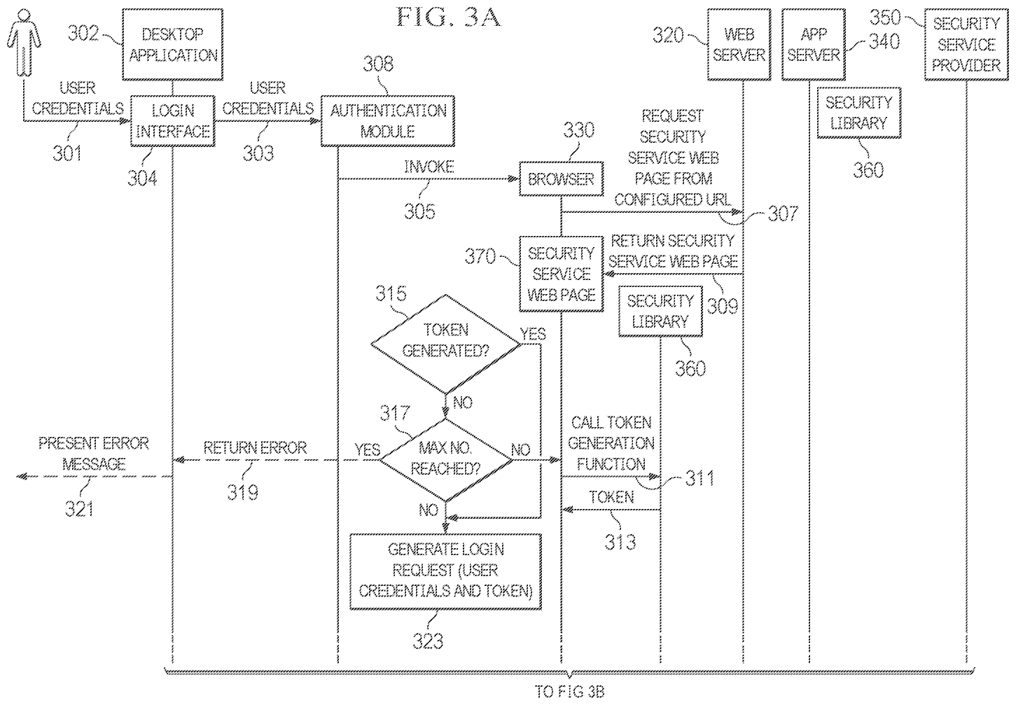

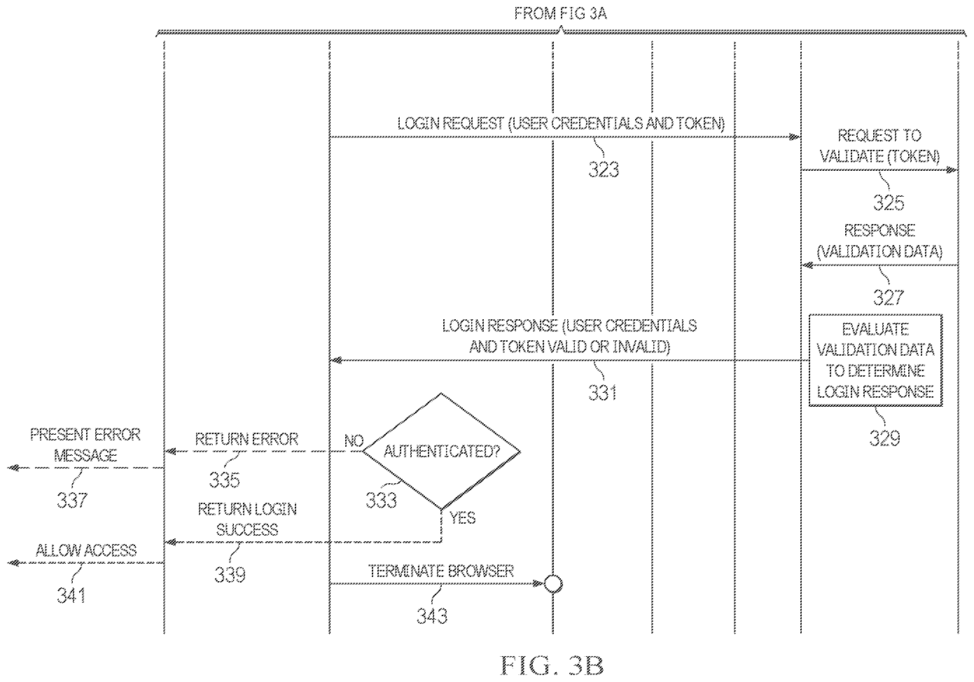

FIG. 3 is a hybrid diagram depicting an architecture and method to incorporate a security service into a login flow (or other type of user verification or validation) for a desktop application in a desktop computing environment. Initially, a user may start, and interact with, desktop application 302 to access desired functionality offered by the desktop application 302. As an initial interaction desktop application 302 may present a login user interface 304a where the user may enter user credentials (e.g., a username such as an email and a corresponding password) that may be received by the login interface (STEP 301).

When a user provides such credentials through this login interface 304 (e.g., an enters “return” or clicks a “login” button), login interface 304 (e.g., code of the page comprising the login interface 304) may be adapted to invoke or otherwise execute authentication module 308 and pass the authentication module 308 the user credentials (STEP 303). These user credentials are thus received by authentication module 308.

The authentication module 308 may, in turn, invoke or otherwise create web browser 330 (STEP 305). Web browser 330 may issue a security service web page request to a configured URL (e.g., an HTTP GET for the URL) (STEP 307). A (e.g., web) server 320 corresponding to this URL may receive this security service web page request and respond to the request by returning security service web page 370 to the browser 330 (STEP 309).

The returned security service web page 370 may incorporate security library 360 associated with security service provider 350. As the security service web page 370 includes the security library 360 for security service provider 250, the security service web page 370 may call a token generation function of the security library to generate a request token (STEP 311). The request token may (or may not) be generated and returned to the security service web page 370 (STEP 313).

Authentication module 308 can thus determine if a token was returned in response to the call to the token generation function of security library 360 (STEP 315). If a token was not returned in response to the call (N branch of STEP 315) it can be determined if a maximum number of attempts (e.g., calls) have been made to generate a token (e.g., 3 attempts, 5 attempts, etc.) (STEP 317). If a maximum number of attempts have been made (Y branch of STEP 317) an authentication response for an error may be returned from the authentication module 308 to the login interface 304 (STEP 319) where this authentication response may cause the login interface 304 to present an error message to a user (STEP 321). If a maximum number of attempts have not been made (N branch of STEP 317) the token generation function of the security library may again be called to generate a request token (STEP 311).

When a token is generated in response to a call to a token generation function (Y branch of STEP 315), authentication module 308 may generate a login request to an authentication service at application server 340 (STEP 323). This request may be an HTTP POST and include, for example, the user credentials (e.g., username and password provided by the user) and the request token generated by the security library 360.

When the login request from authentication module 308 is received at the application server 340, the authentication service at the application server 340 may utilize security library 360 to generate a request for validation to security service provider 350, where that request may include the request token (e.g., as received in the request from authentication module 308) (STEP 325).

Security service provider 350 can then perform the validation requested by the received validation request and return a validation response to authentication service on application server 340 (STEP 327). This validation response may include validity data determined by security service provider 350 based on the validation request (e.g., based on the request token in the received validation request) such as a risk score, binary approval, or other validity data.

Authentication service can then evaluate the validation data received from the security service provider 350 (and other data such as the user credentials) to determine a login response to the login request from authentication 308 module (STEP 329). In particular, authentication service at the application server 340 may determine whether to authenticate the user based on the validity data returned from security service provider 350 (e.g., and the submitted username and password, etc.). The application server 340 can then send this login response back to authentication module 308, where that login response may include authentication data responsive to the login request, including for example an indication of the validity of the request token, username or password or an approval or denial of the authentication of the user (STEP 331).

Authentication module 308 can then use the authentication data included in the login response to make a determination whether the user was authenticated (STEP 333) to either allow the user access to (e.g., functionality of) desktop application 302 or deny the user access to desktop application 302. If the user was not authenticated (N branch of STEP 333) an authentication response for an error may be returned from the authentication module 308 to the login interface 304 (STEP 335) where this authentication response may cause the login interface 304 to present an error message to a user (STEP 337). If the user is authenticated (Y branch of STEP 333) an authentication response for a successfully logged in user may be provided to login interface 304 (STEP 339). This authentication response may cause the login interface to update the desktop application interface, present another interface of the desktop application or otherwise allow a user access to the functionality of desktop application 302 (STEP 341). Additionally, authentication module 308 may cleanup or terminate, including termination and cleanup of browser 330 (STEP 343).

Embodiments as disclosed, or portions thereof, are implemented on a computing system. Any combination of mobile desktop, server machine, cloud deployed servers (virtual or actual) or containers, embedded or other types of hardware, etc. may be used as such computing systems. Those skilled in the relevant art will appreciate that the invention can be implemented or practiced with other computer system configurations including, without limitation, cloud deployed computing systems or server (E.g., either physical or virtual), multi-processor systems, network devices, mini-computers, mainframe computers, data processors, and the like. The invention can be embodied in a general-purpose computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet.

In a distributed computing environment, program modules or subroutines may be located in both local and remote memory storage devices. These program modules or subroutines may, for example, be stored or distributed computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature, or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a set of distributed computers communicatively coupled to a network (for example, the Internet). Any suitable programming language can be used to implement the routines, methods, or programs of embodiments of the invention described herein, including C, C++, Java, Javascript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

A “computer-readable medium” may be any medium that can contain, store, communicate, propagate, or transport the program for use by or in connection with the instruction execution system, apparatus, system, or device. The computer readable medium can be, by way of example only but not limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

What is claimed is:

1. A method for incorporating use of services into desktop applications, comprising:
at a desktop application executing on a computing device:
determining an access to an interface of the desktop application;
executing a service access module, the service access module adapted for:
invoking a web browser in the service access module, the web browser configured to access a Uniform Resource Locator (URL) for a service access web page associated with a first service and including a library associated with the first service;
receiving the service access web page including the library;
utilizing the service access web page, calling the library associated with the first service to generate, at the computing device, client side service data associated with the first service;
sending, from the service access module at the computing device, a first request including the client side service data to an intermediary server, wherein the first request is for a second service from provided by the intermediary server, wherein:
the first request causes a second request to be sent from the intermediary server to a service provider of the first service, the second request including the client side service access data,
a first response to the second request is received from the service provider at the intermediary server, wherein the first response including service data determined by the service provider,
a second response to the first request is determined at the intermediary server based on the service data from the from the first response, and
the second response is returned to the service access module at the computing device; and
updating, by the service access module, the desktop application based on the second response.

2. The method of claim wherein the web browser is executing in a process space of the service access module.

3. The method of claim 2, wherein the web browser is confined to accessing only the configured URL.

4. The method of claim 1, wherein the interface is a login interface of the desktop application.

5. The method of claim 4, wherein the service access data generated by the library is a request token associated with the computing device.

6. The method of claim 5, wherein the service data includes a risk access score associated with the request token.

7. The method of claim 6, wherein the first request includes a username and password provided through the login interface and the request token generated by the library.

8. A system, comprising:
a desktop computing device, comprising:
a processor;
a non-transitory computer readable medium, comprising instructions for:
a desktop application having an interface;
a service access module, wherein the instructions are further for:
determining an access to the interface of the desktop application;
executing the service access module, the service access module for:
invoking a web browser in the service access module, the web browser configured to access a Uniform Resource Locator (URL) for a service access web page associated with a first service and including a library associated with the first service;
receiving the service access web page including the library;
utilizing the service access web page, calling the library associated with the first service to generate, at the computing device, client side service data associated with the first service;
sending, from the service access module at the computing device, a first request including the client side service data to an intermediary server, wherein the first request is for a second service from provided by the intermediary server, wherein:
the first request causes a second request to be sent from the intermediary server to a service provider of the first service, the second request including the client side service access data,
a first response to the second request is received from the service provider at the intermediary server, wherein the first response including service data determined by the service provider,
a second response to the first request is determined at the intermediary server based on the service data from the from the first response, and
the second response is returned to the service access module at the computing device; and
updating, by the service access module, the desktop application based on the second response.

9. The system of claim 8, wherein the web browser is executing in a process space of the service access module.

10. The system of claim 9, wherein the web browser is confined to accessing only the configured URL.

11. The system of claim 8, wherein the interface is a login interface of the desktop application.

12. The system of claim 11, wherein the service access data generated by the library is a request token associated with the computing device.

13. The system of claim 12, wherein the service data includes a risk access score associated with the request token.

14. The system of claim 13, wherein the first request includes a username and password provided through the login interface and the request token generated by the library.

15. A non-transitory computer readable medium, comprising instructions for:
at a desktop application executing on a computing device:
determining an access to an interface of the desktop application;
executing a service access module, the service access module adapted for:
invoking a web browser in the service access module, the web browser configured to access a Uniform Resource Locator (URL) for a service access web page associated with a first service and including a library associated with the first service;
receiving the service access web page including the library;
utilizing the service access web page, calling the library associated with the first service to generate, at the computing device, client side service data associated with the first service;
sending, from the service access module at the computing device, a first request including the client side service data to an intermediary server, wherein the first request is for a second service from provided by the intermediary server, wherein:
the first request causes a second request to be sent from the intermediary server to a service provider of the first service, the second request including the client side service access data,
a first response to the second request is received from the service provider at the intermediary server, wherein the first response including service data determined by the service provider,
a second response to the first request is determined at the intermediary server based on the service data from the from the first response, and
the second response is returned to the service access module at the computing device; and
updating, by the service access module, the desktop application based on the second response.

16. The non-transitory computer readable medium of claim 15, wherein the web browser is executing in a process space of the service access module.

17. The non-transitory computer readable medium of claim 16, wherein the web browser is confined to accessing only the configured URL.

18. The non-transitory computer readable medium of claim 15, wherein the interface is a login interface of the desktop application.

19. The non-transitory computer readable medium of claim 18, wherein the service access data generated by the library is a request token associated with the computing device.

20. The non-transitory computer readable medium of claim 19, wherein the service data includes a risk access score associated with the request token.

21. The non-transitory computer readable medium of claim 20, wherein the first request includes a username and password provided through the login interface and the request token generated by the library.
